(19) United States
(12) Patent Application Publication
(10) Pub. No.: US 2012/0255638 A1
(43) Pub. Date: Oct. 11, 2012

(54) HYDRAULIC CONTROL VALVE HAVING A PILOT PISTON ARRANGED INSIDE THE HOLLOW SPOOL

(75) Inventors: Thomas Lehner, Schleiden (DE); Frank Baumanns, Willich-Anrath (DE); Viktor Vogel, Monchengladbach (DE); Walter Krips, Grevenbroich (DE)

(73) Assignee: Parker Hannifin Manufacturing Germany GmbH & Co. KG, Bielefeld (DE)

(21) Appl. No.: 13/288,230

(22) Filed: Nov. 3, 2011

(30) Foreign Application Priority Data
Nov. 5, 2010 (DE) 102010050323.1

(51) Int. Cl. F15B 13/042; F16K 11/07

(52) U.S. Cl. 137/625.69; 137/625.6

(57) ABSTRACT

A hydraulic control valve with a main stage, having spool valves movable in a valve housing having at least four ports and provided with control edges formed on piston collars. A hydraulic pilot stage is provided to control the spool valve of the main stage, and is characterized by the fact that the spool valve of the main stage is designed hollow to form the hydraulic pilot stage. The wall of the hollow spool valve has at least one opening, to which a piston collar formed on the pilot valve is assigned with two control edges arranged on the outside, and in which the pilot valve penetrates a thrust plate inserted into the valve housing, enclosing the spool valve and creating a front pressure chamber for the spool valve to form a defined constant outflow path for the hydraulic fluid introduced into the annular space between spool and pilot valves.

### SUMMARY

The invention concerns a hydraulic control valve with a main stage, having a spool valve movable in a valve housing with at least four ports P, A, B, T to block or release the ports, and provided with control edges formed on piston collars, and with a hydraulic pilot stage provided to control the spool valve of the main stage.

If the spool valve of a hydraulic control valve requires a control to release or block the valve housing ports, in addition to electromechanical pilot valves, hydraulically operating pilot stages are also known, in which a pilot valve, controlled by means of a connected drive, regulates a stream of hydraulic fluid acting upon the spool valve of the hydraulic main stage and therefore moving the spool valve between its control positions. When a hydraulic pilot stage, arranged separately from the valve housing of the main stage, is provided, a corresponding large size is obtained for such a hydraulic control valve and therefore a correspondingly large space requirement.

The underlying task of the invention is to provide a hydraulic control valve with a hydraulic pilot stage that has limited space requirement. The solution to this task is obtained, including advantageous embodiments and modifications of the invention, from the content of the claims, which follow this description.

In its main idea, the invention proposes that the spool valve of the main stage be designed hollow to form the hydraulic pilot stage, and a pilot valve movable by an external drive with a diameter smaller than the cavity be arranged in the cavity formed in the spool valve and be movable relative to the spool valve, the wall of the hollow spool valve having at least one opening in its area connected to the pump port P of the control valve, to which a piston collar formed on the pilot valve with two control edges arranged on the outside is connected, and in which the pilot valve, with its axial ends, penetrates a thrust plate inserted into the valve housing, enclosing the spool valve and creating a pressure chamber for the spool valve on the front sealed on the housing side to form a defined constant outflow path for the hydraulic fluid introduced into the annular space between the spool valve and the pilot valve.

The advantage that the pilot stage is moved into the main stage of the hydraulic control valve and the space requirements for the control valve overall are therefore reduced is initially connected with the invention. For this purpose, the invention exploits in a special way the hydraulic principle that the pilot stage, with the pilot valves movable in both axial directions, operates with four resistances, i.e., two resistances in each movement direction of the pilot valve, of which the resistances on the inflow side are controllable in the form of control edges of the pilot valve cooperating with the opening formed in the spool valve of the main stage, whereas the resistances on the outflow side are made in the form of the passage of the corresponding end of the pilot valve through the connected thrust plate for constant flow volume of hydraulic fluid. The advantage of a particularly simple mechanical design, especially of the pilot stage, and simple manufacture of the control valve is connected with this.

The resistance of the pilot stage on the outflow side is then set according to the use conditions for the hydraulic control valve, so that displacement of the pilot valve as free of loss as possible by the connected drive is possible, on the one hand, but, on the other hand, adequate control speeds of the control valve are attainable via the sufficiently large fluid flow.

According to one practical example of the invention, it can then be prescribed that each end of the pilot valve penetrate the thrust plate in an aperture formed in it and the outflow path be formed by an annular gap defined between the pilot valve and the thrust plate, in which case it can be expediently prescribed that the pilot valve penetrate the aperture of the thrust plate with an annular collar formed on it and the annular gap be formed between the surface of the annular collar and the inside wall of the aperture formed in the thrust plate.

In order to ensure the most frictionless possible displacement of the pilot valve in the interior of the spool valve, on the one hand, and maintenance of a defined distance between the pilot valve and the thrust valve, on the other, according to one practical example of the invention, it can be prescribed that the pilot valve be supported against the inside wall of the cavity formed in the spool valve via annular support collars mounted on its periphery, and that at least one axial indentation be formed in the outer periphery of the support collar. Through the axial indentation arranged in the outside periphery of the support collar, overflow of the support collar is made possible in the annular space existing between the spool valve and the pilot valve. Preferably, four indentations can then be arranged over the periphery of the annular collar distributed in a symmetric arrangement.

According to one embodiment of the invention, it is prescribed that a plurality of openings leading into the cavity of the spool valve be arranged over the periphery of the spool valve distributed in a symmetric arrangement, in which case at least two opposite openings can be expedient.

With respect to design of the piston collar on the pilot valve forming the outer control edges, it can be prescribed that the pilot valve be provided with a peripheral groove.

In order to create the pressure chamber required for axial displacement of the spool valve of the main stage of the hydraulic control valve, according to a practical example of the invention, it is prescribed that the thrust plate have a peripheral recess to accommodate an axial protrusion of the spool valve on the front as a stop for the end position of the spool valve, whose depth is chosen so that, in the end position of the spool valve, an intermediate space remains between the thrust plate and the front of the spool valve as pressure chamber.

It can be expediently prescribed that a zero overlap be formed between the opening formed on the spool valve and the connected control edges of the pilot valve.

### BRIEF DESCRIPTION OF THE DRAWINGS

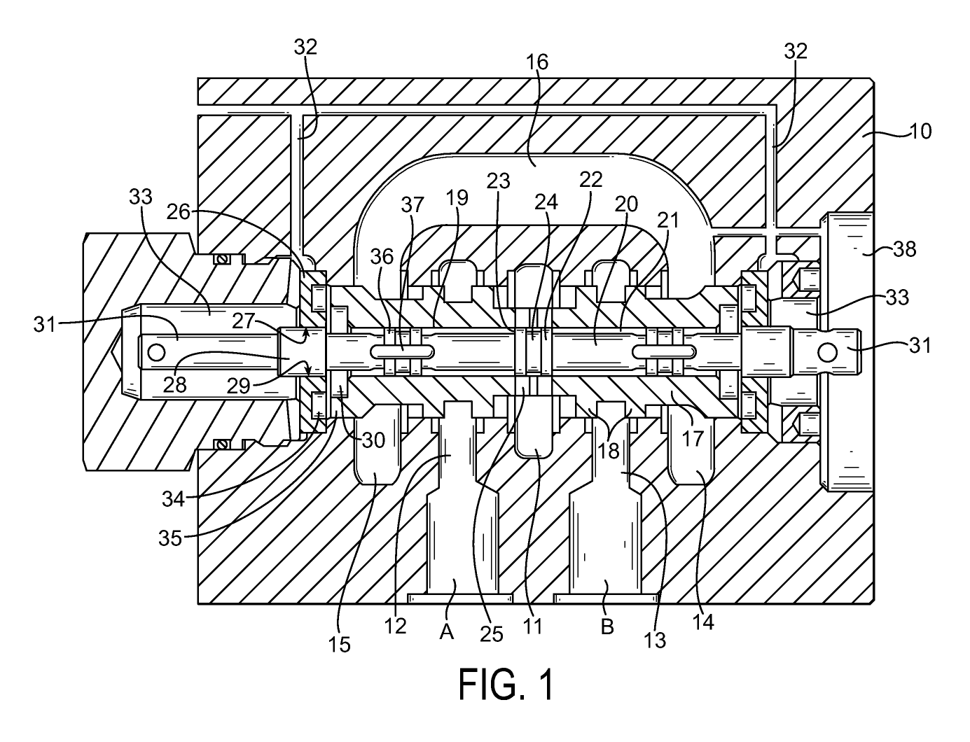

A practical example of the invention is depicted in the drawing, which is described below. The single FIGURE (FIG. 1) shows a hydraulic control valve with integrated pilot stage in a cross-section without depicting the connected drive for the pilot stage and other safety devices to be provided on a control valve, which are not affected by the invention.

### DETAILED DESCRIPTION

On the valve housing 10 of a hydraulic control valve shown in FIG. 1, four standard ports P, A, B, T are formed, as such ports are common, but of which only the ports A and B are visible in the drawing. In known fashion, annular spaces are assigned to the ports in the valve housing 10, specifically an annular space 11 for the pump port P, an annular space 12 for the consumer port A and an annular space 13 for the consumer port B. Outer annular spaces 14 and 15 are also arranged in the depicted practical example, which are assigned to the tank port T, in which case the annular space 14 can be directly connected to the tank port T, whereas the annular space 15 is connected the annular space 14 via an internal bridge 16 and therefore to tank port T.

In the context of the design of the control valve known to this extent, a spool valve 17 is arranged movable in valve housing 10, on which two piston collars 18 with outer control edges are arranged, the piston collars 18 blocking annular spaces 12 and 13 in the neutral position of the control valve depicted in the drawing. During displacement of the spool valve 17, port of the annular space 11 either to annular space 12 or 13 occurs, in which case the other annular space 12 or 13 is connected accordingly to one of the annular spaces 14 or 15. In this way, the annular spaces 12, 13 of the consumer ports A, B are either acted upon with pump pressure or connected to the tank port.

To form a hydraulic pilot valve, the spool valve 17 is designed hollow and has an internal cavity 19, in which the pilot valve 20 is arranged movable relative to the spool valve. The pilot valve 20 has a smaller diameter than the cavity 19 of the spool valve 17, so that an annular space 21 is produced for flow of a hydraulic fluid.

A piston collar with outside control edges 23 is arranged on the pilot valve 20, which has a peripheral groove 24 for pressure equalization in the center. The piston collar 22 of the pilot valve 20 cooperates with two oppositely arranged openings 25 of the spool valve in the depicted practical example, which are connected to the annular space 11 connected to pump port P, so that the hydraulic fluid supplied by the pump is present on the openings 25 of spool valve 17. If a displacement of the pilot valve 20 to the left or right from the neutral position depicted in the drawing occurs, the connected control edge 23 of the piston collar 22 releases the corresponding opening 25, so that hydraulic fluid flows into the annular space 20, depending on the position of the pilot valve 20 in the cavity 19 of spool valve 17. The space penetrated by the spool valve 17 and traversed during its control movement is closed by thrust plates 26 tightly arranged in valve housing 10 relative to the valve housing. The two thrust plates 26 each have a central aperture 27, through which the corresponding end 31 of the pilot valve 20 is passed, specifically to form a defined constant outflow path. Since the pilot valve 20 is provided with an annular collar 28 in the area of aperture 27 in the corresponding thrust plate 26, the defined constant outflow path is formed by an established annular gap 29 between the annular collar 28 and the inside wall of the aperture 27 formed in the thrust plate 26.

A pressure chamber 30, into which annular space 21 discharges, is formed between the thrust plate 26 and the front end of the spool valve 17. The thrust plates 26 each have a peripheral recess 34, set up to accommodate an axially protruding protrusion 35 arranged on the front of the spool valve 17. The depth of the recess 34 is dimensioned relative to the axial extent of the protrusion 35, so that in the end position of the spool valve 17, in which its axial protrusion 35 has entered the recess 34 of the thrust plate 26, an intermediate space remains between the thrust plate 26 and the front of the spool valve 17 as pressure chamber 30.

A functional space 33, in which hydraulic fluid flowing over annular gap 29 enters, is formed in the valve housing 10 on the side of the thrust plate 26 facing away from the spool valve; a discharge line 32 is connected to the functional space, which leads to one of the annular spaces 14 or 15 assigned to the tank port T, so that the hydraulic fluid to be diverted from the functional space can flow out to the tank. Additional safety devices, like return springs, measurement systems or the like, not necessary for understanding of the invention, can be arranged in the functional space.

To support the pilot valve 20 during its movement in the cavity 19 of the spool valve 17, the pilot valve 20 is provided on both sides of its piston collar 22 with an annular support collar 36, by means of which the pilot valve 20 is guided relative to the spool valve 17 during its axial movement. In order to permit passage of hydraulic fluid over the area of the support collars 36, they are provided on their outer periphery with axially running indentations 37 arranged distributed over the periphery, via which the hydraulic fluid introduced to annular space 21 can overflow.

In the depicted practical example on the right end 31 of the pilot valve 20, an opening 38 is formed in the valve housing 10 for connection of an external, preferably electromechanical drive for the pilot valve 20.

If the pilot valve 20 is displaced leftward, for example, by means of the drive (not shown) from the neutral position depicted in the drawing, the right control edge 23 of the piston collar 22 formed on the pilot valve 20 in the drawing depiction releases the opening 25 in the spool valve 17, so that hydraulic fluid supplied by the pump flows rightward into the annular cavity 21 and passes the right support collar 36 in its axial indentations 37 and flows into the pressure chamber 30 connected to the annular space 21 between the thrust plate 26 and the front end of the spool valve 17. The pressure that builds up here leads to displacement of the spool valve 17 leftward, in which case the spool valve 17 reduces the existing pressure chamber 30 and enters the recess 34 of the thrust plate 26 with its peripheral protrusion 35.

The hydraulic fluid necessarily displaced from the pressure chamber 30 can flow over the annular gap 29 into the functional space 33 and from here to the tank via the discharge line 32. If the annular gap 29 on the pressure side of the spool valve 17 is also opened, so that hydraulic fluid flows out during pressure buildup in pressure chamber 30, sufficient hydraulic fluid is introduced to the pressure chamber 30 in relation to the outflow amount for sufficient pressure buildup to occur.

The features of the object of this document, disclosed in the preceding description, the claims, summary, and drawing, can be essential individually and in any combinations with each other for implementation of the invention in its different variants.

1. Hydraulic control valve with a main stage, having spool valves movable in a valve housing having at least four ports P, A, B, T to block or release the ports and provided with control edges formed on piston collars, and with a hydraulic pilot stage provided to control the spool valve of the main stage, characterized by the fact that the spool valve (17) of the main stage is designed hollow to form the hydraulic pilot stage, and a pilot valve (20) movable by an external drive in the cavity formed in spool valve (17) is arranged with a smaller diameter relative to the cavity and forming an annular space (21) on this account and is movable relative to the spool valve (17), the wall of the hollow spool valve (17) being provided with a central inflow opening (25) and with an outer outflow opening (27) on both sides of it, and piston collars (22, 28, 36) forming control edges cooperating with the inflow window (25) and the outflow windows (27) are arranged on the pilot valve (20), and that two thrust plates (26) that enclose the spool valve (17) on its front ends and create a front pressure chamber (30) for the spool valves (17) closed off on the housing side are arranged in the valve housing (10), and the corresponding pressure chamber (30) is connected to the annular space (21) connected to the inflow opening (27) via an inflow path that bridges the piston collars (28, 36) of the pilot valve assigned to the outflow openings (27).

2. Hydraulic control valve according to claim 1, characterized by the fact that the pilot valve (20) has a piston collar (28) that penetrates the pressure chamber (30) and the corresponding thrust plate (26) in a bearing opening, and that the outflow openings (27) in the spool valve (17) are formed as openings open to the tank port (14, 15) in its neutral position, which are blocked in the neutral position of the pilot valve (20) within the spool valve (17) by the corresponding piston collar (28) of the pilot valve (20).

3. Hydraulic control valve according to claim 2, characterized by the fact that the inflow path is formed as a flat spot (29) of the pilot valve (20) that forms a flow space between the pilot valve (20) and the spool valve (17) and the outflow opening (27) formed in the spool valve (17) is arranged with an angular offset to the flat spot (29) formed on the pilot valve (20), and that a torsion safeguard (31, 32) is provided for non-torsional guiding of the spool valve (17) in the valve housing (10) and the pilot valve (20) relative to each other in all control positions.

4. Hydraulic control valve according to claim 2, characterized by the fact that the inflow path is formed as a hole that penetrates the piston collars (28) assigned to the outflow openings (27) and connects the pressure chamber (30) to annular space (21).

5. Hydraulic control valve according to claim 2, characterized by the fact that the inflow path is formed as a hole running in the wall of the spool valve (17) and connecting the pressure chamber (30) to annular space (21).

6. Hydraulic control valve according to claim 1, characterized by the fact that the outflow openings (27) in the spool valve (17) are assigned in its neutral position to the consumer ports A and B and piston collar (36) forming two control edges for the outflow openings is arranged on the pilot valve (20), which are blocked in the neutral position of the pilot valve (20) within the spool valve (17) by the corresponding piston collar (36) of the pilot valve (20).

7. Hydraulic control valve according to claim 6, characterized by the fact that the inflow path is formed as a hole (37) that penetrates the piston collar (36) assigned to the outflow openings (27) and connecting the pressure chamber (30) to annular space (21).

8. Hydraulic control valve according to claim 6, characterized by the fact that the inflow path is formed as a flat spot formed on the piston collar (36) of the pilot valve (20) assigned to the outflow openings (27) and the corresponding outflow openings (27) formed in the spool valve (17) are arranged with an angular offset to the flat spots formed on the piston collars of the pilot valve, and that a torsion safeguard is provided in the valve housing for non-torsional guiding of the spool valve and the pilot valve relative to each other in all control positions.

9. Hydraulic control valve according to one of the claims 1 to 8, characterized by the fact that a plurality of inflow openings (25) and outflow openings (27) leading into the cavity of the spool valve (17) are arranged over the periphery of the spool valve (17) distributed in symmetric arrangement.

10. Hydraulic control valve according to one of the claims 1 to 9, characterized by the fact that the thrust plates (26) have a peripheral recess (34) to accommodate an end axial protrusion (35) of the spool valve (17) as a stop for the end position of the spool valve (17), whose depth is dimensioned so that an intermediate space remains between the thrust plate (26) and the end of the spool valve (17) as a pressure chamber in the end position of the spool valve (17).
